(19) United States
(12) Patent Application Publication
(10) Pub. No.: US 2026/0336428 A1
(43) Pub. Date: Oct. 29, 2026

(54) CONTROL SYSTEM HAVING LOW ENERGY RANGE EXTENDING MODE FOR ELECTRIFIED VEHICLE

(71) Applicant: FCA US LLC, Auburn Hills, MI (US)

(72) Inventors: Francis James Carr, II, Auburn Hills, MI (US); Brian John Morrison, Auburn Hills, MI (US); Perry Dulaney Francois-Edward, Auburn Hills, MI (US); Alexander Yohei Morita, Auburn Hills, MI (US); Thomas Andrew Clifford, Auburn Hills, MI (US)

(21) Appl. No.: 19/191,329

(22) Filed: Apr. 28, 2025

(51) Int. Cl. B60L 15/20; B60L 58/12

(52) U.S. Cl. CPC B60L 15/2045; B60L 58/12; B60L 2240/12; B60L 2240/54

(57) ABSTRACT

A control system and method for an electrified vehicle having an electric motor that is powered by a high voltage battery system includes: a sensor that receives an external driving input indicative of a speed limit and outputs a speed limit signal; a vehicle grade sensor that determines a grade the vehicle is operating along and outputs a grade signal; and a controller that: determines a state of charge (SOC) of the high voltage battery system; receives the speed limit signal; receives the grade signal; determines a maximum commanded power output signal based on the SOC, speed limit signal and grade signal; and commands the electric motor to operate at the maximum commanded power output signal.

### FIELD

The present application generally relates to electrified vehicles and, more particularly, to a controller that implements a low energy range extending mode based on a battery low state of charge and external driving inputs.

### BACKGROUND

An electrified vehicle (battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. Some electrified vehicles implement a speed limiting mode that limits vehicle speed to a fixed value based on a low state of charge of the high voltage battery system. Operating the vehicle in such a speed limiting mode will extend the range of the vehicle, however presents other drawbacks. For example, controlling vehicle speed to a fixed limit can cause drivability concerns when the desired speed is around or above the controlled speed limit. Accordingly, while such speed limiting modes do work well for their intended purpose, there is a desire for improvement in the relevant art.

### SUMMARY

According to one example aspect of the invention, a control system for an electrified vehicle having an electric motor that is powered by a high voltage battery system includes: a sensor that receives an external driving input indicative of a speed limit and outputs a speed limit signal; a vehicle grade sensor that determines a grade the vehicle is operating along and outputs a grade signal; and a controller that: determines a state of charge (SOC) of the high voltage battery system; receives the speed limit signal; receives the grade signal; determines a maximum commanded power output signal based on the SOC, speed limit signal and grade signal; and commands the electric motor to operate at the maximum commanded power output signal.

In some implementations, the controller determines the maximum commanded power output signal based on a road load coefficient.

In some implementations, the sensor is a camera.

In some implementations, the external driving input is a speed limit sign.

In some implementations, the sensor is a global positioning sensor.

In additional aspects, the external driving input is a global positioning system speed.

In additional features, the controller continuously determines the maximum commanded power output signal in real-time based on real-time receipt of the SOC, speed limit signal and grade signal, and commands the electric motor to operate in real-time at the maximum commanded power output signal.

In other features, a method of controlling an electrified vehicle is provided. The electrified vehicle has an electric motor that is powered by a high voltage battery system, a sensor that receives an external driving input indicative of a speed limit and outputs a speed limit signal, and a vehicle grade sensor that determines a grade the vehicle is operating along and outputs a grade signal. The method includes: determining, at a controller, a state of charge (SOC) of the high voltage battery system; receiving, at the controller, the speed limit signal; receiving, at the controller, the grade signal; determining, at the controller, a maximum commanded power output signal based on the SOC, speed limit signal and grade signal; and commanding the electric motor to operate at the maximum commanded power output signal.

In additional arrangements of the method, the controller determines the maximum commanded power output signal based on a road load coefficient.

In some examples of the method, the sensor is a camera.

In implementations of the method, the external driving input is a speed limit sign.

In examples of the method, the sensor is a global positioning sensor.

In other examples of the method, the external driving input is a global positioning system speed.

In additional features of the method, the controller continuously determines the maximum commanded power output signal in real-time based on real-time receipt of the SOC, speed limit signal and grade signal, and commands the electric motor to operate in real-time at the maximum commanded power output signal.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having a propulsion system, a battery system and a control system that implements an intelligent low energy range extending mode (ILEREM) that limits output power of the propulsion system to a power level based on external driving inputs including a displayed speed limit and road grade according to various principles of the present application;

FIG. 2 is an exemplary plot of control speed, vehicle speed and accelerator pedal input over time for a vehicle controller that implements a speed limiting mode accordance to one Prior Art example;

FIG. 3 is an exemplary plot of speed limit, maximum power output and actual power output over time for the control system of FIG. 1 according to various principles of the present application;

FIG. 4 is a schematic illustration of the control system of FIG. 1 shown receiving external driving inputs from a vehicle camera system and outputting a maximum power output for the propulsion system based on the external driving inputs according to various principles of the present application; and

FIG. 5 is a logic flow diagram illustrating exemplary steps implemented by the control system of FIG. 1 according to various principles of the present application.

### DESCRIPTION

As discussed above, some electrified vehicles implement a speed limiting mode that limits vehicle speed to a fixed value based on a low state of charge of the high voltage battery system. Operating the vehicle in such a speed limiting mode will extend the range of the vehicle, however presents other drawbacks. Controlling vehicle speed to a fixed limit can cause drivability concerns when the desired speed is around or above the controlled speed limit. For example, if a driver is driving in traffic and the controlled speed limit is 70 kilometers per hour (kph), and the posted speed limit is 75 kph, the driver will be slowing down and speeding up around that 70 kph. If the driver desires to go faster, they must apply the accelerator pedal to near 100% input to override the controlled speed limit. Controlling vehicle speed in such a scenario can be frustrating to the driver. In other disadvantages of current speed limiting control systems, during accelerations below the fixed limit control speed, the vehicle can output any amount of power. High power output is less efficient use of the remaining energy inside the battery pack.

The instant disclosure provides a control system that implements an intelligent low energy range extending mode (ILEREM) based on a battery low state of charge and external driving inputs. In examples, the control system limits the power of the propulsion system to a power level calculated from the displayed speed limit and road grade. The limiting power is the power required to keep the vehicle at the displayed speed limit taking into account road grade, plus an offset. The power required to keep the vehicle at a given speed is calculated using road load coefficients as a function of speed limit plus grade compensation, plus an offset. The power limiting feature is activated based on a state of charge (SOC) of the high voltage battery is below a threshold. The ILEREM feature will automatically reduce the output power of the vehicle to help extend the range of the vehicle by forcing a more efficient application of the remaining energy. The ILEREM feature is also capable of being overridden by the driver during aggressive accelerator pedal input to allow the driver to accelerate in extreme operating conditions.

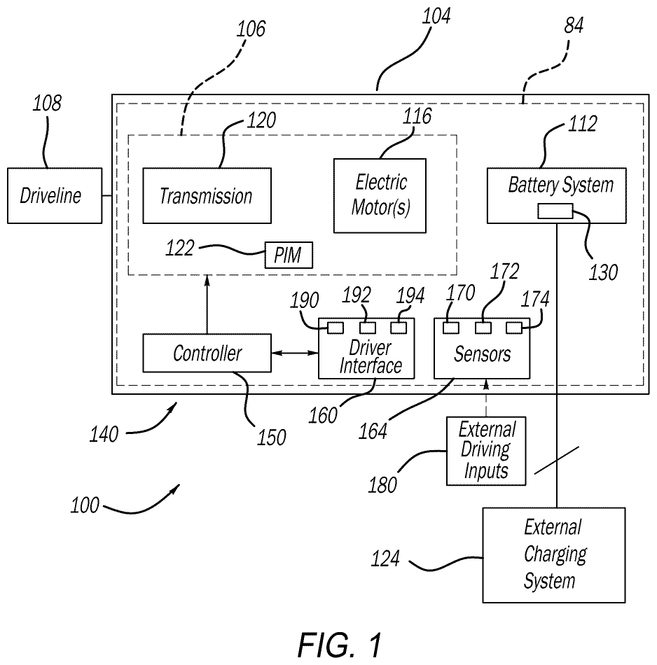

Referring now to FIG. 1, a functional block diagram of an example electrified vehicle 100 (also referred to herein as “vehicle 100”) according to the principles of the present application is illustrated. The vehicle 100 includes a propulsion system or electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 124 to a high voltage battery system 112 for powering the electric motor(s) 116. The battery system 112 is selectively connectable (e.g., by the driver) to an external charging system 124 (also referred to herein as “charger 124”) for charging of the battery system 112. The battery system 112 includes at least one battery module assembly 130. A control system 140 implements an intelligent low energy range extending mode (ILEREM) that limits output power of the propulsion system 104 to a power level based on external driving inputs including a displayed speed limit and road grade. The control system includes a controller 150 that provide various inputs to the EDM 106 such as a maximum power output limit implemented based on a low state of charge of the battery system 112.

The control system 140 communicates with a driver interface 160 and sensors 164 provided on the vehicle 100. The sensors 164 can include a vehicle camera 170, a vehicle grade sensor 172 and global positioning sensor(s) 174. Additional vehicle sensors may be provided. In examples, the vehicle camera 170 can receive an external driving input 180, such as a vehicle speed limit sign. In additional examples, the control system 140 can obtain the speed limit based on the global positioning sensor(s) 174.

While FIG. 1 illustrates a controller 150, one or more controllers are utilized to control the various vehicle components or system discussed above. In one exemplary implementation, various individual controllers are utilized to control the various components/systems discussed herein and are in communication with each other and/or the various components/systems via a local interface 84. In this exemplary implementation, the local interface 84 is one or more buses or other wired or wireless connections, as is known in the art. In the example illustrated in FIG. 1, the local interface 84 is a controller area network (CAN). The CAN 84 may include additional elements or features, which have been omitted for simplicity, such as controllers, buffers (cache) drivers, repeaters and receivers, among many others, to enable communications. Further, the CAN 84 may include address, control and/or data connections to enable appropriate communications among the components/systems described herein.

The driver interface 160 can include a driver input device, e.g., an accelerator pedal 190, for providing a driver input, e.g., a torque request, for the EDM 106. The driver interface 160 can further include a human-machine interface (HMI) 192 that is configured to receive inputs from, and communicate vehicle information to, a driver. The driver interface 160 can further include additional interface devices 194 such as, but not limited to, a steering wheel, and a brake pedal.

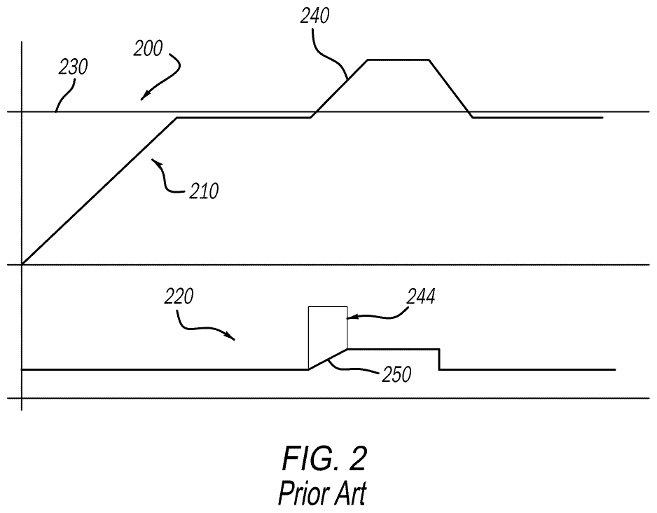

With additional reference now to FIG. 2, an exemplary plot of control speed 200, vehicle speed 210, and accelerator pedal input 220 over time is shown for a vehicle controller that implements a speed limiting mode accordance to one Prior Art example. As mentioned above, prior art speed limiting modes limit vehicle speed based on a low battery state of charge. For example, when the controller determines that the high voltage battery has a state of charge below a threshold (e.g., such as but not limited to, below 10% or 5%) the controller limits the vehicle control speed to a fixed control speed 230. When a driver desires to operate the vehicle above the fixed control speed, generally identified at 240, the accelerator pedal needs to operate within the tip in region 244. The tip in region 244 can represent an accelerator pedal input of at or near 100% to override the fixed control speed 230. It is undesirable for a driver to navigate within the tip in region 244. Instead, a driver would be more comfortable operating along a normal and preferred driving trace 250.

As discussed herein, control according to this prior art example does not account for road conditions such as traffic requiring the vehicle to drive at different speeds. Operation in this fixed control speed can lead to driver frustration and poor drivability of the vehicle. This prior art example also does not provide any efficiency improvements if the vehicle is driving at speeds below the fixed control speed. Output power is able to be expended without any limitation.

The control system 140 of the present disclosure implements an intelligent low energy range extending mode (ILEREM) based on a low state of charge of the battery system 112 and external driving inputs. The power required to maintain the vehicle 100 at a given speed is calculated using road load coefficients as a function of speed limit plus grade compensation plus an offset. In examples, the speed limit can be determined based on an input received by the camera 170 based on a speed limit sign 180. In other examples, the speed limit can be determined based on an input received by the global positioning sensor(s) 174. A grade (e.g., incline the vehicle 100 is operating along) can also be determined by the vehicle grade sensor 172.

The control system 140 implements the ILEREM by following an algorithm that calculates a maximum allowable power output of the propulsion system 104.

Max Power Output=k_{tolerance}×[A×Vₗᵢₘᵢₜ³+B×Vₗᵢₘᵢₜ²+C×Vₗᵢₘᵢₜ+P_{grade}].

Where: k_{tolerance} is an allowable tolerance; A, B, C are the road load coefficients f(speed); P_{grade} is the additional power required to oppose gravity=mg sin θ; m is the estimated mass of the vehicle 100; and Vₗᵢₘᵢₜ is the speed limit determined from the camera 170. In general, the road load coefficients are specific characteristics of the vehicle 100 and can be proportional to an amount of power needed to maintain a vehicle speed.

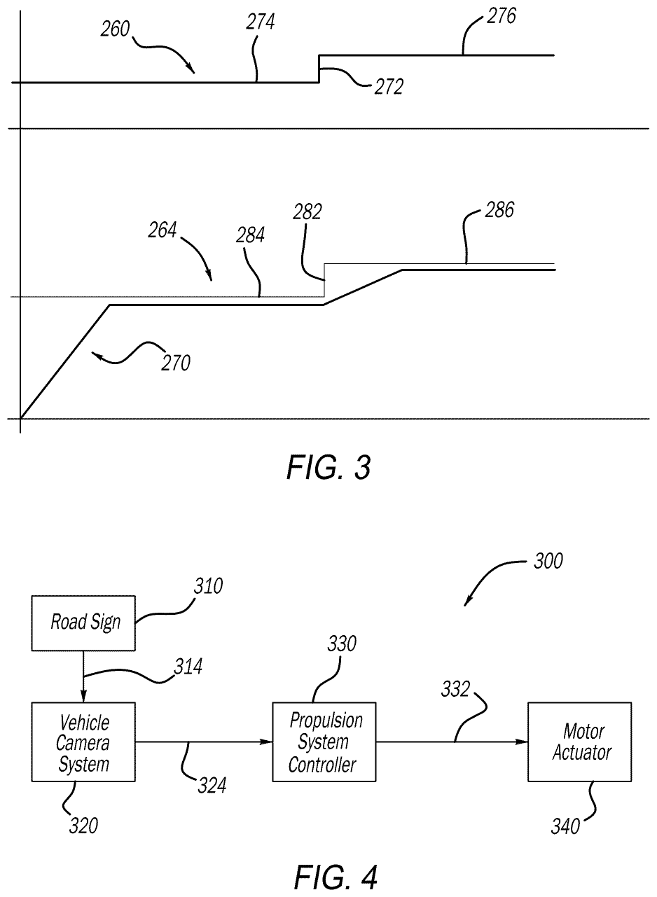

With reference now to FIG. 3, an exemplary plot of speed limit 260, maximum power output 264 and actual power output 270 over time is shown for the control system 140 of FIG. 1 according to various principles of the present application. As discussed above, the speed limit 260 can be determined from the camera 170. At 272, the control system 140 determines, based on a signal from the camera 170, that the speed limit has increased from a first speed limit 274 to a second speed limit 276. As a result, the control system 140, implementing the ILEREM sets the maximum power output 264. Notably, control system 140 recalculates the maximum power output based on the new speed limit that occurred at 272. The maximum power output changes accordingly at 282 that increases from a first maximum power output 284 (that corresponds to first speed limit 274), to a second maximum power output 286 (that corresponds to the second speed limit 276).

FIG. 4 is a schematic illustration 300 of the control system 140 of FIG. 1 shown receiving external driving inputs 314 from a road sign 310 (e.g., external driving inputs 180, FIG. 1). In examples, a vehicle camera system 320 (e.g., camera 170, FIG. 1) can receive the driving inputs 314 indicative of a speed limit. The vehicle camera system 320 can output a speed limit signal 324 based on the driving input 314. A propulsion system controller 330 (e.g., controller 150, FIG. 1) can receive the speed limit signal 324 from the vehicle camera system 320 indicative of a detected speed limit. The propulsion system controller 330 can output a maximum commanded power output signal 332 indicative of a maximum power threshold to a motor actuator 340 (e.g., for the propulsion system 104).

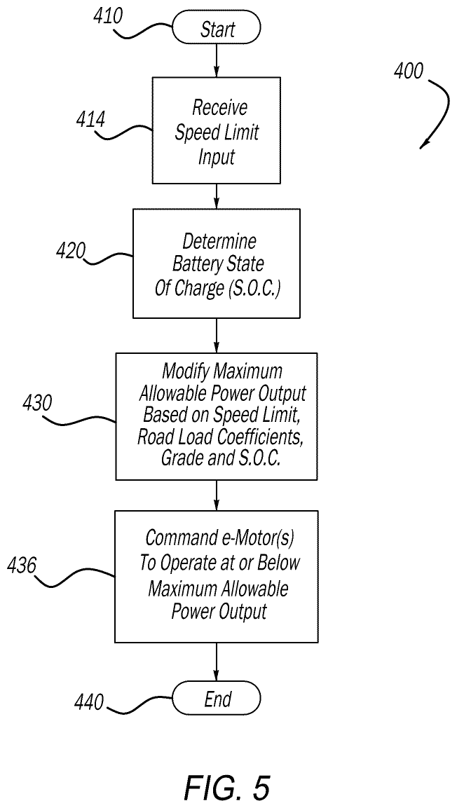

With additional reference to FIG. 5, a logic flow diagram 400 illustrating exemplary steps implemented by the control system 140 of the present disclosure is shown. Control starts at 410. At 414 control receives a speed limit input 314. Control can additionally receive other operating conditions such as, but not limited to, a grade signal from the grade sensor 172 at step 414. Again, the speed limit input 414 can be obtained by the camera 170 that reads a speed limit sign 180. At 420, control determines a battery state of charge of the battery system 112. At 430, control modifies the maximum allowable power output of the propulsion system 104 based on the speed limit and the battery state of charge. At 436, control commands the electric motor(s) 116 (EDM 106) to operate at or below the maximum allowable power output. Control ends at 440. It will be appreciated that control continually receives a signal 324 for the speed limit input 414 and modifies the maximum allowable power output signal 332 in real time based on the received speed limit input 414. As a result, the controller 150 will limit the maximum power output of the EDM 106 (electric motor(s) 116) to the calculated maximum allowable power output. As the speed limit changes, a new maximum power output of the EDM 106 is calculated in real-time.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

1. A control system for an electrified vehicle having an electric motor that is powered by a high voltage battery system, the control system comprising:
a sensor that receives an external driving input indicative of a speed limit and outputs a speed limit signal;
a vehicle grade sensor that determines a grade the vehicle is operating along and outputs a grade signal; and
a controller that:
determines a state of charge (SOC) of the high voltage battery system;
receives the speed limit signal;
receives the grade signal;
determines a maximum commanded power output signal by applying road load coefficients as a function of the speed limit signal and the grade signal, and based on the SOC being below a threshold; and
commands the electric motor to operate at the maximum commanded power output signal.

2. (canceled)

3. The control system of claim 1, wherein the sensor is a camera.

4. The control system of claim 3, wherein the external driving input is a speed limit sign.

5. The control system of claim 1, wherein the sensor is a global positioning sensor.

6. The control system of claim 5, wherein the external driving input is a global positioning system speed.

7. The control system of claim 1, wherein the controller continuously determines the maximum commanded power output signal in real-time based on real-time receipt of the SOC, speed limit signal and grade signal, and commands the electric motor to operate in real-time at the maximum commanded power output signal.

8. A method of controlling an electrified vehicle having an electric motor that is powered by a high voltage battery system, a sensor that receives an external driving input indicative of a speed limit and outputs a speed limit signal, and a vehicle grade sensor that determines a grade the vehicle is operating along and outputs a grade signal, the method comprising:
determining, at a controller, a state of charge (SOC) of the high voltage battery system;
receiving, at the controller, the speed limit signal;
receiving, at the controller, the grade signal;
determining, at the controller, a maximum commanded power output signal based on the SOC, speed limit signal and grade signal; and
limiting output power of the electric motor to the maximum commanded power output signal to extend a driving range of the electrified vehicle.

9. The method of claim 8, wherein the controller determines the maximum commanded power output signal based on a road load coefficient.

10. The method of claim 8, wherein the sensor is a camera.

11. The method of claim 10, wherein the external driving input is a speed limit sign.

12. The method of claim 8, wherein the sensor is a global positioning sensor.

13. The method of claim 12, wherein the external driving input is a global positioning system speed.

14. The method of claim 8, wherein the controller continuously determines the maximum commanded power output signal in real-time based on real-time receipt of the SOC, speed limit signal and grade signal, and commands the electric motor to operate in real-time at the maximum commanded power output signal.

15. A control system for an electrified vehicle having an electric motor powered by a high voltage battery system, the control system comprising:
a sensor that receives an external driving input indicative of a posted speed limit and outputs a speed limit signal;
a vehicle grade sensor that determines a grade of a road along which the vehicle is operating and outputs a grade signal; and
a controller configured to:
determine a state of charge (SOC) of the high voltage battery system;
compare the SOC to a threshold value;
in response to the SOC falling below the threshold value, activate a range extending mode in which the controller:
calculates a maximum allowable power output of the electric motor using road load coefficients as a function of the posted speed limit, a grade compensation term based on the grade signal, and an allowable tolerance offset, wherein the road load coefficients are vehicle-specific parameters proportional to the power required to maintain vehicle speed; and
commands the electric motor to operate at or below the calculated maximum allowable power output while permitting driver override of the range extending mode in response to an accelerator pedal input exceeding a predetermined threshold.
